(19) United States
(12) Patent Application Publication
(10) Pub. No.: US 2007/0000225 A1
(43) Pub. Date: Jan. 4, 2007

(54) Cranberry-Harvesting Apparatus and Method

(76) Inventor: Daniel Brockman, Vesper, WI (US)

Correspondence Address: JANSSON, SHUPE, MUNGER & ANTARAMIAN, LTD, 245 MAIN STREET, RACINE, WI, 53403, US

(21) Appl. No.: 11/470,709

(22) Filed: Sep. 7, 2006

Related U.S. Application Data
(63) Continuation-in-part of application No. 10/760,445, filed on Jan. 20, 2004, now Pat. No. 7,121,075.

(51) Int. Cl. A01D 46/00

(52) U.S. Cl. 56/328.1

(57) ABSTRACT

An apparatus and method for harvesting cranberries, the method including moving frame-mounted transverse dislodging rods through cranberry plants with each rod moving at the speed of the frame, thereby to dislodge cranberries from the cranberry plants. The apparatus includes a plurality of dislodging rods secured below the frame, the dislodging rods positioned substantially parallel to the field surface and generally perpendicular to the direction of movement whereby each dislodging rod is moved through the cranberry plants at the speed of the frame to dislodge the cranberries from the plants. Certain preferred embodiments use follower assemblies to configure an array of dislodging rods in an advantageous arrangement. In highly preferred embodiments, the mounted dislodging rods are such that the rods under load deflect in a plane substantially parallel to the field surface. The apparatus may include resiliently flexible dislodging rods.

### RELATED APPLICATION

This application is a continuation-in-part of co-pending U.S. patent application Ser. No. 10/760,445, filed Jan. 20, 2004, by the inventor named herein, the entire content of said application of which is incorporated herein by reference.

### FIELD OF THE INVENTION

This invention is related to cranberry harvesting and, more particularly, to cranberry-harvesting equipment and methods.

### BACKGROUND OF THE INVENTION

Cranberries are raised in fields or bogs, which are relatively flat areas divided into sections so that the fields can be flooded both to facilitate harvesting and to protect the vines from frost. The cranberry plants form a mat of vines which may be up to twelve or fourteen inches deep. During harvesting, the berries are removed from the vines and float to the surface of the water. The berries are then gathered up for transport to a processing facility.

Traditional methods of harvesting cranberries and the equipment used to implement such methods generally fall into two categories. Both traditional methods have drawbacks which will be described herein later.

The first general method can be characterized as “beating” and is carried out using equipment which includes beaters which are bars mounted on combine-like revolving structures. U.S. Pat. No. 3,672,140 (Burford) discloses equipment based on this principal. As the harvesting vehicle moves through the cranberry bog, a rotating wheel with transverse bars to agitate the cranberry vines, causes the cranberries to detach from the plants. The rotation of the wheel causes the transverse bars to move through the cranberry vines at a speed greater than the vehicle speed at the position of principal contact with the plants. Cranberries float to the surface of the flooded bog and are gathered up. U.S. Pat. No. 4,501,111 issued to Abbott describes another harvester unit which uses such a rotating wheel approach.

The second general method can be characterized as picking or raking. U.S. Pat. No. 2,524,631 (Minutillo) describes a harvesting machine based on this method. A series of combs mounted on a rotating wheel is moved through the cranberry plants to detach the cranberries from the vines. U.S. Pat. No. 5,067,047 (Rosset) discloses harvesting equipment which employs vertically-oscillating tines to strip the cranberries from the vines. Rosset then collects the stripped cranberries through a vacuum suction unit.

As mentioned above, the methods and equipment which are used for cranberry harvesting have certain drawbacks. As in any commercial endeavor, increased productivity is in general a desired performance. Typical harvesting rates for the cranberry-harvesting equipment commonly used today is on the order of 0.5 acres per hour, with maximum rates being about 1.5 acres per hour. Productivity is also affected by the fraction of the fruit which is removed from the vines during harvesting. A higher fraction yields higher productivity.

Some of this equipment is quite “aggressive” in how it treats the cranberry plants, often resulting in damage both to harvested fruit as well as the vines. In addition, much of the equipment used today includes a number of moving parts, often driven by hydraulic equipment. The operation of hydraulic equipment during harvesting creates the risk of the fruit becoming contaminated with hydraulic fluid. Also, the complexity of the equipment translates into increased maintenance cost.

Finally, for cranberries which are sold as fresh fruit rather than processed into juice or other consumer food products, not only is it advantageous to prevent damage to the fruit, it is also of great benefit to avoid wetting the fruit during harvesting. As mentioned above, the fields or bogs are flooded, allowing the fruit which has been separated from the plants to float, thereby facilitating the collection of the fruit. However, the fruit, being now wet, is subject to the growth of fungus or requires the additional costly step of drying in order to deliver fresh, unblemished fruit to the market. Because of this, it is advantageous to dry-harvest cranberries to avoid these problems or costs.

Therefore, there is a need for simple, rapid and efficient, low-cost method and apparatus to harvest cranberries.

### OBJECTS OF THE INVENTION

It is an object of this invention, in the field of cranberry-harvesting, to provide a cranberry-harvesting apparatus and method which harvest cranberries at substantially higher rates (acres per hour) than existing harvesting equipment and methods.

Another object is to provide cranberry-harvesting apparatus which is mechanically simple and requires a minimum of maintenance.

Another object is to a provide cranberry-harvesting apparatus and method which remove a higher fraction of the cranberries from the vines than existing harvesting equipment and method.

Another object is to provide cranberry-harvesting apparatus which can be both pushed or pulled through the field of cranberry vines.

Another object is to provide cranberry-harvesting apparatus which reduces the risk of contamination of the fruit being harvested.

Still another object is to provide cranberry-harvesting apparatus which reduces the damage to the cranberries being harvested.

Yet another object is to provide a cranberry-harvesting apparatus and method which can be used for both wet and dry harvesting of cranberries.

These and other objects of the invention will be apparent from the following descriptions and from the drawings.

### SUMMARY OF THE INVENTION

The invention is a method and apparatus for harvesting cranberries, whereby frame-mounted transverse dislodging rods are moved through cranberry plants with each rod moving at the speed of the frame, thereby dislodging cranberries from the cranberry plants. The cranberry-harvesting apparatus of this invention comprises a frame movable over a field of cranberries in a forward direction with a plurality of follower assemblies each secured to and below the frame by a support. Each follower assembly includes: a rod mount having a lower portion, a surface-following leading end, and a pivot attachment to the support at the lower portion behind the center-of-gravity of the follower assembly; and first and second pairs of dislodging rods mounted to the rod mount forward and rearward of the pivot attachment respectively, each pair extending laterally from opposite sides of the lower portion substantially parallel to the field surface and canted rearwardly. Each rod mount is supported such that it moves through the cranberry plants at the speed of the frame to dislodge the cranberries from the plants.

In certain highly preferred embodiments of the inventive cranberry-harvesting apparatus, the mounted dislodging rods are such that the rods under load deflect in a plane substantially parallel to the field surface.

In another preferred embodiment of the cranberry-harvesting apparatus, the dislodging rods are resiliently flexible.

In yet another embodiment of the apparatus, the dislodging rods are spring-mounted. Certain preferred embodiments of such apparatus include each dislodging rod having a coiled proximal end forming a spring.

In a preferred embodiment of the cranberry-harvesting apparatus, each rod mount is a vertical plate having a rod anchor member and each dislodging rod has a length and a proximal end in relationship to the rod mount. In most preferred embodiments of such apparatus, the rod anchor member defines an opening for receiving and supporting the proximal end of a corresponding dislodging rod. And, in highly preferred embodiments, each dislodging rod extends outwardly from the opening and substantially parallel to the field surface. Each mounted rod is adapted to, under load, deflect in a plane substantially parallel to the field surface. In another preferred embodiment of the apparatus, the dislodging rods have a substantially circular cross-section.

In highly preferred embodiments of the cranberry-harvesting apparatus, the frame has a major axis generally perpendicular to the movement thereof and parallel to the field surface. Each dislodging rod has a free distal end, and the follower assemblies are laterally spaced substantially equally along the major axis in alternating forward and rearward positions thereby forming offset forward and rearward gangs of adjacent assemblies such that the distal ends of the dislodging rods of adjacent assemblies overlap along the major axis. The distal ends of the dislodging rods of adjacent assemblies of each gang are spaced apart along the direction of movement.

In highly-preferred embodiments of the cranberry-harvesting apparatus, the frame includes a principal cross-member, and each support includes a longitudinal arm pivotably mounted to the cross-member.

In some embodiments of the cranberry-harvesting apparatus, each longitudinal arm is downwardly spring-biased against the field surface. In such embodiments, it is most preferred that such apparatus include: an anchor arm affixed to the cross-member and having a first connection spaced therefrom; a second connection on the longitudinal arm spaced from the cross-member; and a spring linkage between the first and second connections such that the longitudinal arm moves under load with respect to the anchor arm to provide the downward biasing. In some embodiments, each surface-following leading end is substantially convex.

In other embodiments of the cranberry-harvesting apparatus, the frame is operator-movable up and down such that the surface-following leading ends can be positioned in and out of contact with the field surface.

Some highly-preferred embodiments of the invention further include a drive apparatus to move the frame over a field of cranberries. In some embodiments, the frame is mounted to the front of the drive apparatus, and in other embodiments, the frame is mounted to the back of the drive apparatus.

Certain embodiments of the cranberry-harvesting apparatus include at least one vacuum nozzle behind the follower assemblies whereby the dislodged cranberries are picked up by vacuum suction. Some embodiments include a vacuum nozzle behind each of the follower assemblies. A collection container may also be included in such apparatus.

In another embodiment, inventive cranberry-harvesting apparatus includes dislodging rods where each rod is mounted at the proximal end of the rod with respect to one of the vertical plate(s) and extends laterally and transverse with respect to the direction of movement. The dislodging rods together are substantially in a single plane parallel to the field surface. In most highly-preferred embodiments, substantially the entirety of each rod is substantially in the single plan parallel to the field surface.

Broadly considered, the cranberry-harvesting apparatus includes a frame movable over a field of cranberries in a forward direction and a plurality of support-rod assemblies each secured with respect to the frame. The support-rod assemblies include a rod mount and at least one dislodging rod mounted to the rod mount, each rod including a portion which extends laterally and transverse with respect to the direction of movement and is substantially in a single plane parallel to the field surface. In other embodiments, a pair of dislodging rods is mounted to the rod mount.

The inventive method for harvesting cranberries from a cranberry field includes moving frame-mounted, free-ended dislodging rods through cranberry plants with each rod moving at the speed of the frame. The mounted rods are adapted to deflect under load, such deflections being substantially in a single plane parallel to the field surface. In one form of the inventive method of harvesting cranberries, deflecting of the rods includes resilient flexing thereof. Another embodiment of the inventive method includes the steps of vacuuming up dislodged cranberries immediately after dislodgement and collecting the cranberries in a collection container.

As used herein, the following terms have the meanings given below, unless the context requires otherwise.

The term “deflect” as used herein includes a complex range of motion and contemplates that the dislodging rods may not always be parallel, in whole or in part, to the field surface. Rather, the rods will undergo slight changes in direction of movement as the cranberry-harvesting apparatus moves through the field and the rods come into contact with the cranberry plants.

The term “flexing” is used herein to describe the characteristic of the dislodging rods where the rods are pliant or flexible such that each rod is capable of slightly bending and then reverting to its original position.

The term “field surface” refers to the surface of the cranberry field from which cranberries are being harvesting. Most typically, this will be the upper surface of a mat of cranberry vines as compressed by the dislodging rods (rather than the surface of the soil).

The term “resiliently” as used herein means able to recoil or spring back into shape after flexing.

The term “surface-following” is used herein to describe one function of the leading end of a follower assembly, indicating that the leading end enables the follower assembly to move over the field surface in a path which conforms to the contour of the field surface without digging into the field surface or becoming entangled with vegetation.

### BRIEF DESCRIPTION OF THE DRAWINGS

FIG. 1 is a perspective view of one embodiment of the inventive cranberry-harvesting apparatus;

FIG. 2 is a side elevation of the embodiment shown in FIG. 1;

FIG. 3 is a top plan view of the embodiment of FIG. 1 with the first-from-the-left of the longer longitudinal arms partially removed;

FIG. 4 is a side elevation of the inventive apparatus, including drive apparatus to pull the frame over the field of cranberries;

FIG. 5 is a side elevation of the inventive apparatus, including drive apparatus to push the frame over the field of cranberries;

FIG. 6 is yet another perspective view of an embodiment of the invention showing dislodging rods having coiled proximal ends; and

FIG. 7 is a side elevation of the inventive apparatus shown in FIG. 5 further including one vacuum nozzle behind each of the follower assemblies and a collection container.

### DETAILED DESCRIPTION

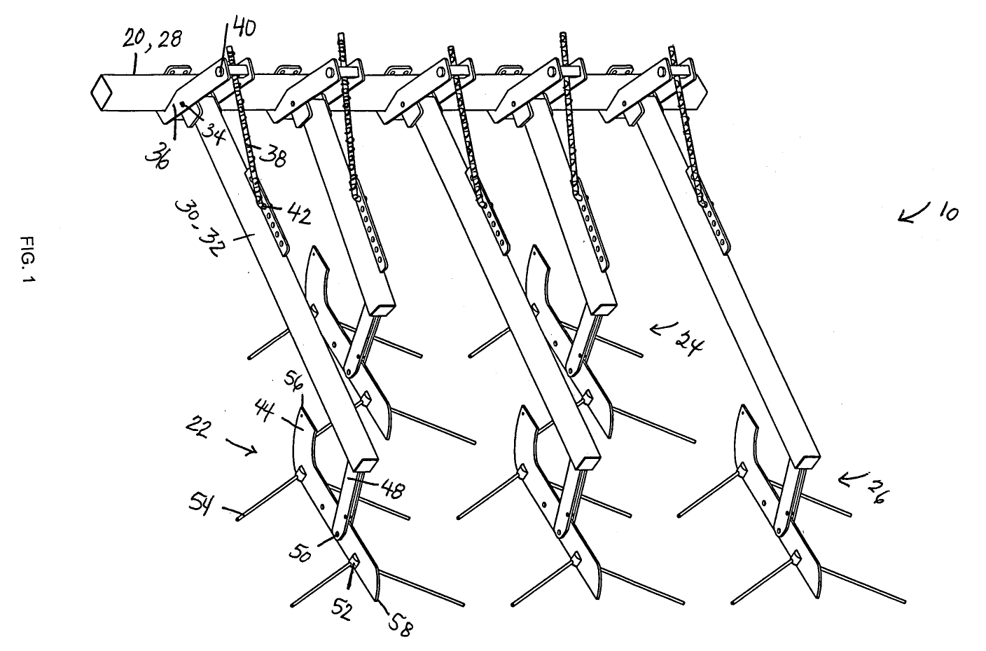

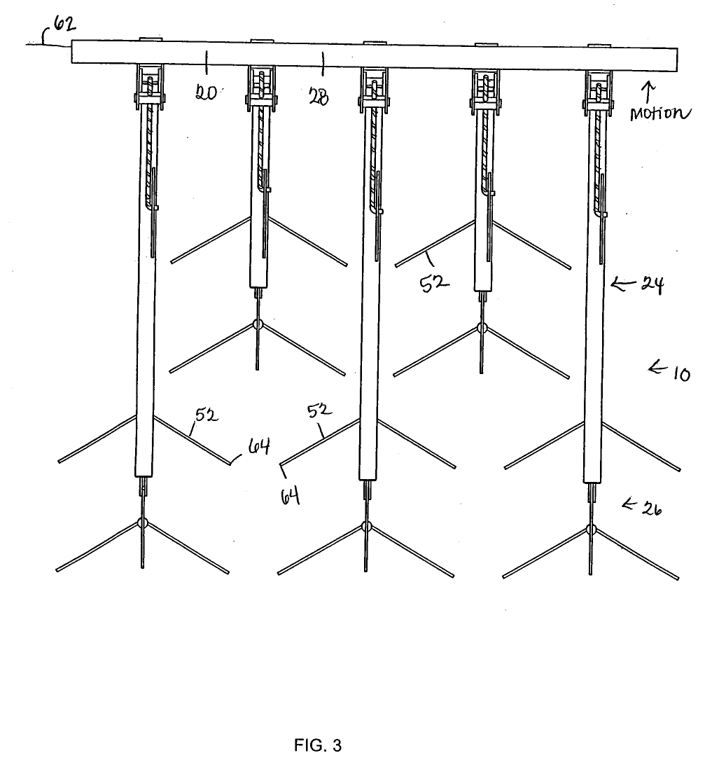

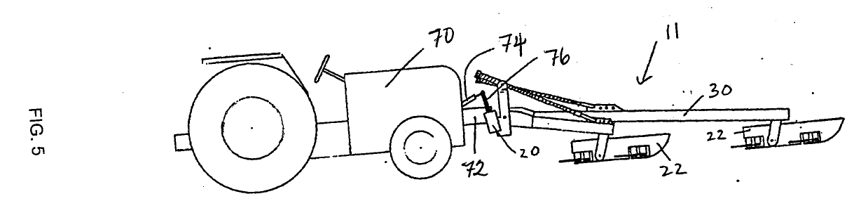

FIGS. 1-4 show a cranberry-harvesting apparatus 10 which is one embodiment of this invention. Apparatus 10 is configured to be pulled over a cranberry field. Apparatus 10 has a frame 20 which is pulled over a cranberry field in the direction indicated in FIG. 3. Apparatus 10 includes ten follower assemblies 22 configured in a forward gang 24 of follower assemblies 22 and a rearward gang 26 of follower assemblies 22. Cranberry-harvesting apparatus 11 of FIG. 5 is configured to be pushed over a cranberry field. This invention is described primarily with reference to apparatus 10; as will be apparent, the two embodiments are substantially similar to each other in their essential elements.

Frame 20 consists primarily of a principal cross-member 28. Each follower assembly 22 is attached to frame 20 by a support 30 (ten supports 30 for ten follower assemblies 22). In FIG. 1, five supports 30 are short and five are long, supporting gangs 24 and 26 respectively. Each support 30 includes an anchor arm 36 rigidly connected to principal cross-member 28, a longitudinal arm 32 which is pivotally mounted to anchor arm 36 by a pivot mount 34 located within anchor arm 36 near cross-member 28, a follower mount 48 affixed to longitudinal arm 32, a follower pivot 50 within follower mount 48 spaced away from longitudinal arm 32, and a spring linkage 38.

Follower assembly 22 is pivotally connected to follower mount 48 at a point within follower assembly 22 such that the center-of-gravity of follower assembly 22 is forward of follower pivot 50. Anchor arm 36 includes a first connection 40 spaced away from principal cross-member 28. Longitudinal arm 32 includes a second connection 42 also spaced away from cross-member 28. Spring linkage 38 is pivotally connected to first connection 40 and second connection 42 such that longitudinal arm 32 is able to pivot around pivot mount 34 as the contour of the field surface changes. Spring linkage 38 exerts a force such that follower assembly 22 is pushed downwardly onto the field surface.

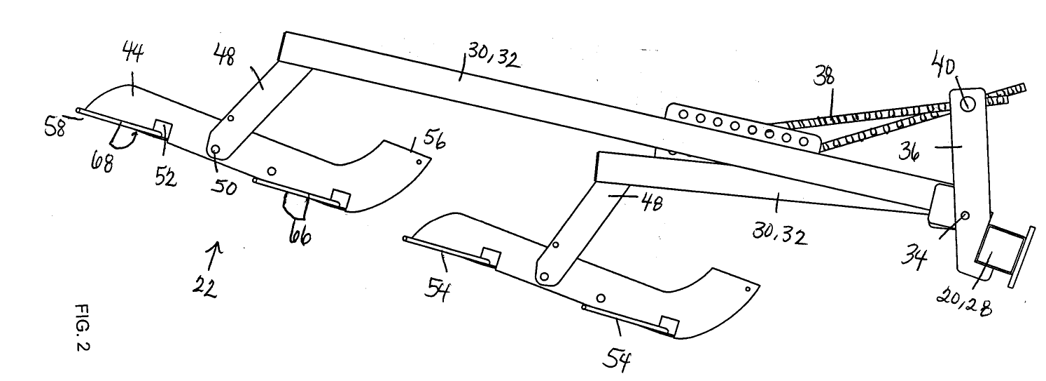

Referring to FIGS. 1-3, each follower assembly includes a rod mount 44 which is comprised of a vertical plate, a rod anchor member 52 affixed to the vertical plate, and at least one dislodging rod 54 mounted to the rod anchor member. The rod anchor member defines an opening for receiving and supporting the proximal end of a corresponding dislodging rod. Each dislodging rod extends outwardly from the opening and substantially parallel to the field surface, each mounted rod being adapted to, under load, deflect in a plane substantially parallel to the field surface. The dislodging rods typically have a circular cross-section as seen in FIGS. 1-2. Rod mount 44 includes a convex surface-following leading end 56 and a lower portion 58. Follower pivot 50 is positioned at lower portion 58, and as noted above, behind the center-of-gravity of follower assembly 22 such that follower assembly 22 moves over the field surface substantially parallel to the field surface.

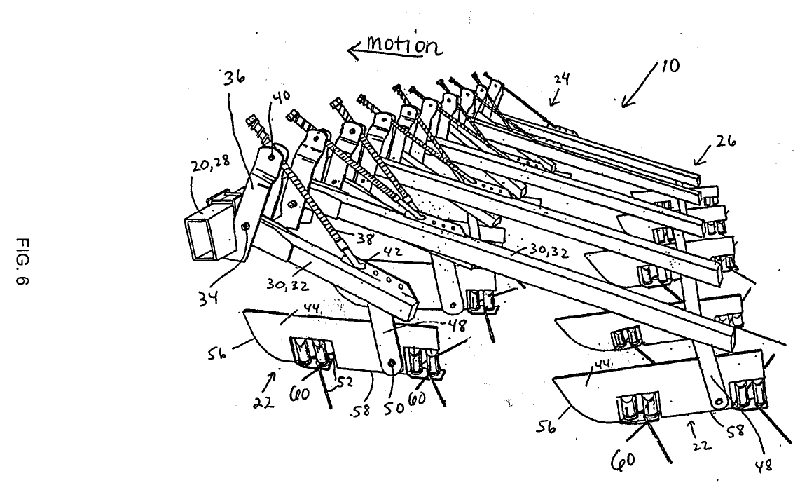

FIG. 6 shows an embodiment of the invention in which the dislodging rods 52 are spring-mounted to the rod mount 44. Each dislodging rod has a coiled proximal end 60 forming a spring.

FIG. 3 is a top plan view of apparatus 10, illustrating the configuration of follower assemblies 22 into forward gang 24 and rearward gang 26. The leftmost follower assembly of rearward gang 26 is partially removed from FIG. 3 to illustrate the relative positions of dislodging rods 52 of neighboring follower assemblies within forward gang 24. Frame 20 has a major axis 62 which is generally perpendicular to the direction of motion of apparatus 10. Each dislodging rod 52 is mounted in an orientation canted at an angle θ with respect to major axis 70 as indicated on the leftmost and forwardmost dislodging rod 52 in FIG. 3. Angle θ is preferably set within the range of 15 to 40 degrees, most preferably about 25 degrees.

Each dislodging rod 52 has a distal end 64, and follower assemblies 22 are positioned within gangs 24 and 26. In one embodiment, the distal ends 64 of neighboring follower assemblies 22 overlap an amount sufficient to ensure that all of the cranberry plants are influenced by dislodging rods 52 as apparatus 10 is moved over the field surface even when dislodging rods 52 are deflected backwards under the load of the cranberry plants. Neighboring dislodging rods 52 of adjacent follower assemblies 22 within gangs 24 and 26 are positioned along the direction of motion with a distance d₁ between distal ends 64 such that cranberry plants which may become caught up on dislodging rods 52 are shed off distal ends 64 as apparatus 10 moves forward over the field surface. Distance d₁ is preferably at least four inches. In another embodiment, the distal ends 64 of neighboring follower assemblies have a distance between them such that the ends do not overlap.

Each follower assembly 22 has first pair 66 and second pair 68 of dislodging rods 52, first pair 66 being positioned forward of second pair 68 by a distance d₂. Distance d₂ is preferably at least 12 inches and more typically between 16 and 18 inches. Distance d₂ is chosen to be sufficient to allow the cranberry plants which are compressed by first pair 66 to rise up before being compressed again by second pair 68. Distance d₂ is therefore dependent on the speed of the forward motion of apparatus 10. High speeds require d₂ to be larger. (Distance d₁ may be about half of distance d₂ or may be significantly less as shown in FIG. 3.)

The distance between forward gang 24 and rearward gang 26 of follower assemblies 22 is typically larger than distance d₂ to ensure that forward gang 24 and rearward gang 26 act on the cranberry plants in an independent fashion.

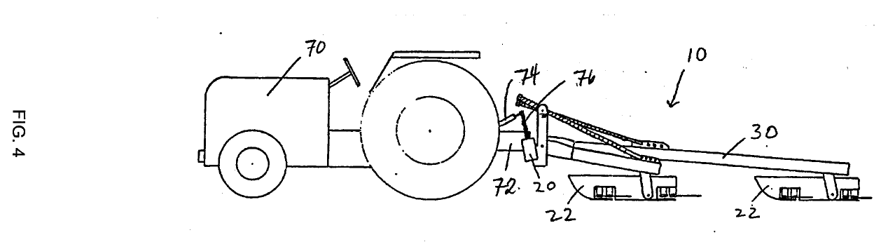

FIGS. 4 and 5 are side elevations simply illustrating the fact that the inventive cranberry-harvesting apparatus can be both pulled (FIG. 4) and pushed (FIG. 5) over the field surface by a drive apparatus 70, typically a farm tractor suitably configured to drive over a cranberry field. Illustrated in both FIGS. 5 and 6, the harvesting apparatus is attached to drive apparatus 70 on a movable hitch 72. Movable hitch 72 is the standard movable hitch typically available on farm tractors to raise and lower farm implements for proper operation. In addition, frame 20 is able to be rotated on hitch 72 by hydraulic actuator 74 acting on frame arm 76, further enabling the height and orientation of apparatus 10 and 11 to be adjusted for proper operation. For example, in apparatus 11 in FIG. 6, follower assemblies 22 are mounted in the opposite direction from that of apparatus 10 with respect to frame 20 and supports 30.

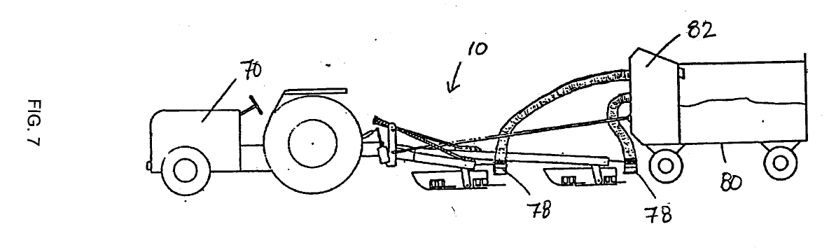

FIG. 7 is a side elevation of the embodiment of FIG. 5 configured for dry harvesting of cranberries. Each follower assembly 22 has mounted immediately behind it a vacuum nozzle 78 connected to vacuum unit 90. Cranberries which are picked up by vacuum unit 90 through vacuum nozzles 88 are deposited into collection container 92.

The general operation of the apparatus 10 is as follows. Apparatus 10 is lowered down onto the field surface such that follower assemblies 22, primarily through dislodging rods 60, compress the cranberry plants from an uncompressed thickness, which is typically on the order of twelve inches, down to a thickness of a few inches. Apparatus 10 is moved forward over the field surface, thereby moving dislodging rods 60 over the field surface at the speed of apparatus 10. As dislodging rods 60 compress the cranberry plants, the cranberry fruit is dislodged from the cranberry plants with a minimum of damage to both fruit and vines. One mechanism by which this dislodging takes place is a squeegee-like action on the field surface. Except those areas covered by the left and right sides of apparatus 10, every point along the field surface is in general acted on by four dislodging rods 60, thereby providing significant opportunity for the cranberry fruit to be released from the cranberry plants.

Typically, apparatus 10 is moved forward over the field surface by drive apparatus 80 at speeds of five or six miles per hour, thereby being able to harvest approximately three acres of cranberries per hour. High-speed harvesting using the inventive apparatus may be carried out in flooded cranberry bogs, with subsequent cranberry recovery carried out using standard methods known in the art for the gathering of floating berries.

Apparatus 10 is able also to be used for dry harvesting of cranberries such that at least a substantial portion of the crop is harvested without being wetted. During dry harvesting, vacuum nozzles 88 mounted immediately behind follower assemblies 22, are used to pick up the cranberries which have been dislodged by dislodging rods 60. Since some of the dislodged cranberries may be trapped within the cranberry plants during dislodgment and vacuuming, the cranberry field may then be flooded and the typical methods for the gathering of dislodged cranberries in flooded fields used to complete the harvest.

While the principles of this invention have been described in connection with specific embodiments, it should be understood clearly that these descriptions are made only by way of example and are not intended to limit the scope of the invention.

1. A cranberry-harvesting apparatus comprising:
a frame movable over a field of cranberries in a forward direction;
a plurality of follower assemblies each secured to and below the frame by a support, each follower assembly including:
a rod mount having a lower portion, a surface-following leading end, and a pivot attachment to the support at the lower portion behind the center-of-gravity of the follower assembly; and
first and second pairs of dislodging rods mounted to the rod mount forward and rearward of the pivot attachment respectively, each pair extending laterally from opposite sides of the lower portion substantially parallel to the field surface and canted rearwardly,
whereby each rod mount is supported such that it moves through the cranberry plants at the speed of the frame to dislodge the cranberries from the plants.

2. The cranberry-harvesting apparatus of claims 1 wherein the mounted dislodging rods are such that the rods under load deflect in a plane substantially parallel to the field surface.

3. The cranberry-harvesting apparatus of claim 2 wherein the dislodging rods are resiliently flexible.

4. The cranberry-harvesting apparatus of claim 2 wherein the dislodging rods are spring-mounted.

5. The cranberry-harvesting apparatus of claim 4 wherein each dislodging rod has a coiled proximal end forming a spring.

6. The cranberry-harvesting apparatus of claim 1 wherein:
the rod mount is a vertical plate having a rod anchor member; and
each dislodging rod has a length and a proximal end in relationship to the rod mount.

7. The cranberry-harvesting apparatus of claim 6 wherein the rod anchor member defines an opening for receiving and supporting the proximal end of a corresponding dislodging rod.

8. The cranberry-harvesting apparatus of claim 7 wherein each dislodging rod extends outwardly from the opening and substantially parallel to the field surface, each mounted rod being adapted to deflect under load in a plane substantially parallel to the field surface.

9. The cranberry-harvesting apparatus of claim 8 wherein the dislodging rods are resiliently flexible.

10. The cranberry-harvesting apparatus of claim 6 wherein the dislodging rods are spring-mounted.

11. The cranberry-harvesting apparatus of claim 10 wherein each dislodging rod has a coiled proximal end forming a spring.

12. The cranberry-harvesting apparatus of claim 1 wherein the dislodging rods have a substantially circular cross-section.

13. The cranberry-harvesting apparatus of claim 1 wherein:
the frame has a major axis generally perpendicular to the movement thereof and parallel to the field surface;
each dislodging rod has a free distal end;
the follower assemblies are laterally spaced substantially equally along the major axis in alternating forward and rearward positions thereby forming offset forward and rearward gangs of adjacent assemblies; and
the distal ends of the dislodging rods of adjacent assemblies of each gang are spaced apart along the direction of movement.

14. The cranberry-harvesting apparatus of claim 13 wherein:
the frame includes a principal cross-member; and
each support includes a longitudinal arm pivotably mounted to the cross-member.

15. The cranberry-harvesting apparatus of claim 14 wherein each longitudinal arm is downwardly spring-biased against the field surface.

16. The cranberry-harvesting apparatus of claim 13 wherein each support further includes:
an anchor arm affixed to the cross-member and having a first connection spaced therefrom;
a second connection on the longitudinal arm spaced from the cross-member; and
a spring linkage between the first and second connections such that the longitudinal arm moves under load with respect to the anchor arm to provide the downward biasing.

17. The cranberry-harvesting apparatus of claim 1 wherein each surface-following leading end is substantially convex.

18. The cranberry-harvesting apparatus of claim 1 wherein the frame is operator-movable up and down such that the surface-following leading ends can be positioned in and out of contact with the field surface.

19. The cranberry-harvesting apparatus of claim 1 further including a drive apparatus to move the frame over a field of cranberries.

20. The cranberry-harvesting apparatus of claim 19 wherein the frame is mounted to the front of the drive apparatus.

21. The cranberry-harvesting apparatus of claim 19 wherein the frame is mounted to the back of the drive apparatus.

22. The cranberry-harvesting apparatus of claim 1 further including at least one vacuum nozzle behind the follower assemblies whereby the dislodged cranberries are picked up by vacuum suction.

23. The cranberry-harvesting apparatus of claim 22 wherein the at least one vacuum nozzle includes one vacuum nozzle behind each of the follower assemblies.

24. The cranberry-harvesting apparatus of claim 22 further including a collection container.

25. An apparatus for harvesting cranberries from a cranberry field, comprising:
a frame movable over the field of cranberries in a forward direction; and
at least one vertical plate secured to the frame and oriented substantially parallel to the direction of movement; and
a plurality of dislodging rods each of which is mounted at its proximal end with respect to one of the vertical plate(s) and extends laterally and transverse with respect to the direction of movement, the rods together being substantially in a single plane parallel to the field surface,
whereby each dislodging rod is moved through the cranberry plants at the speed of the frame to dislodge the cranberries from the plants.

26. The cranberry-harvesting apparatus of claim 25 wherein the dislodging rods are angled slightly rearwardly.

27. The cranberry-harvesting apparatus of claim 25 wherein the mounted dislodging rod has a free distal end such that the mounted rod under load deflects in a plane substantially parallel to the field surface.

28. The cranberry-harvesting apparatus of claim 27 wherein the dislodging rods are resiliently flexible.

29. The cranberry-harvesting apparatus of claim 27 wherein the dislodging rods are spring-mounted.

30. The cranberry-harvesting apparatus of claim 29 wherein each dislodging rod has a coiled proximal end forming a spring.

31. The cranberry-harvesting apparatus of claim 25 including a plurality of follower assemblies, each follower assembly including one of the vertical plates and forward and rearward pairs of dislodging rods, each pair of rods including a rod extending from each side of the plate.

32. The cranberry-harvesting apparatus of claim 31 wherein the follower assemblies are mounted to the frame in alternating forward and rearward positions.

33. The apparatus of claim 25 wherein substantially the entirety of each rod is substantially in the single plane parallel to the field surface.

34. A method of harvesting cranberries from a cranberry field including moving frame-mounted, free-ended dislodging rods through cranberry plants with each rod moving at the speed of the frame, each rod being mounted with respect to the frame and extending laterally and transverse with respect to the direction of movement of the frame, the mounted rods being adapted to deflect under load, such deflections being substantially in a single plane parallel to the field surface, thereby to dislodge cranberries from the cranberry plants.

35. The method of claim 34 wherein deflecting of the rods includes resilient flexing thereof.

36. The method of claim 34 further including the steps of vacuuming up dislodged cranberries immediately after dislodgement and collecting the cranberries in a container.

37. The method of claim 34 wherein substantially the entirety of each rod is substantially in the single plane parallel to the field surface.

38. A cranberry-harvesting apparatus comprising:
a frame movable over a field of cranberries in a forward direction; and
a plurality of support-rod assemblies each secured with respect to the frame and each including:
a rod mount; and
at least one dislodging rod mounted to the rod mount, each rod including a portion which extends laterally and transverse with respect to the direction of movement and is substantially in a single plane parallel to the field surface,
whereby each rod is supported such that it moves through the cranberry plants at the speed of the frame to dislodge the cranberries from the plants.

39. The cranberry-harvesting apparatus of claim 38 wherein the dislodging rods are mounted with respect to the rod mount such that the mounted dislodging rods being adapted to deflect under load, such deflections being substantially in a single plane parallel to the field surface.

40. The cranberry-harvesting apparatus of claim 39 wherein the dislodging rods are resiliently flexible.

41. The cranberry-harvesting apparatus of claim 39 wherein the dislodging rods are spring-mounted.

42. The cranberry-harvesting apparatus of claim 41 wherein each dislodging rod has a coiled proximal end forming a spring.

43. The cranberry-harvesting apparatus of claim 38 wherein the dislodging rods have a substantially circular cross-section.

44. The cranberry-harvesting apparatus of claim 38 further including a drive apparatus to move the frame over the field of cranberries.

45. The cranberry-harvesting apparatus of claim 44 wherein the frame is mounted to the front of the drive apparatus.

46. The cranberry-harvesting apparatus of claim 44 wherein the frame is mounted to the back of the drive apparatus.

47. The cranberry-harvesting apparatus of claim 38 wherein substantially the entirety of each rod is substantially in the single plane parallel to the field surface.

48. The cranberry-harvesting apparatus of claim 38 wherein a pair of dislodging rods is mounted to the rod mount.
